(19) United States
(12) Patent Application Publication
(10) Pub. No.: US 2022/0207626 A1
(43) Pub. Date: Jun. 30, 2022

(54) SYSTEM AND METHOD FOR CONTACTLESS DINING EXPERIENCE

(71) Applicant: Toast, Inc., Boston, MA (US)

(72) Inventors: Katherine L. Swanson, Gloucester, MA (US); Toshit Panigrahi, Nashua, NH (US)

(73) Assignee: Toast, Inc., Boston, MA (US)

(21) Appl. No.: 17/139,875

(22) Filed: Dec. 31, 2020

(51) Int. Cl. G06Q 50/12; G06Q 30/06; G06Q 10/08; G06Q 20/20; G06Q 10/02

(52) U.S. Cl. CPC G06Q 50/12; G06Q 30/0635; G06Q 10/02; G06Q 20/204; G06Q 20/202; G06Q 10/087

(57) ABSTRACT

A method for a contactless experience, comprising: via server, registering guest information, initiating the experience prior to arrival of a guest, wherein said initiating comprises communicating by the server with a smart device corresponding to the guest to pre-order items from a menu and specify initial coursing instructions, and adding the pre-order items to an electronic ticket; detecting arrival of the guest and communicating arrival to the server; continuing said communicating to enable the guest to order additional items and to specify additional coursing instructions, adding the additional items to the electronic ticket, preparing the pre-order and additional items, transmitting notifications to a point-of-sale (POS) terminal of a server assigned to the guest to deliver prepared items to the guest in accordance with the initial and additional coursing instructions; and delivering the prepared items to the guest.

### CROSS-REFERENCE TO RELATED APPLICATIONS

This application is related to the following co-pending U.S. patent applications, each of which has a common assignee and common inventors, the entireties of which are herein incorporated by reference.

| SERIAL NUMBER | FILING DATE | TITLE |
|---|---|---|
| (̅T̅S̅T̅.̅0̅1̅3̅4̅)̅ | — | CONTACTLESS DINING |
| | | EXPERIENCE SYSTEM |
| | | AND METHOD |
| (̅T̅S̅T̅.̅0̅1̅3̅5̅)̅ | — | SYSTEM AND METHOD |
| | | FOR CONTACTLESS POST- |
| | | DINING EXPERIENCE |
| (̅T̅S̅T̅.̅0̅1̅3̅6̅)̅ | — | CONTACTLESS POST-DINING |
| | | EXPERIENCE SYSTEM AND |
| | | METHOD |

### BACKGROUND OF THE INVENTION

### Field of the Invention

This invention relates in general to the field of retail operations, and more specifically to methods and systems for improved automated, contactless retail ordering and fulfillment experiences.

### Description of the Related Art

It is rare these days to walk into a retail store or restaurant that has a manually operated cash register along with manual (i.e., paper and pencil) order entry. Rather, it is more common to find one or more electronic point-of-sale (POS) terminals through which a guest may order goods and/or services. Whether the terminals are employed in a fixed position or hand carried by wait staff, the advantages over prior manual entry mechanisms are pronounced and include more accurate presentation of goods and services, accurate and up to date pricing, customized loyalty presentations, automated transmission of orders for fulfillment, and automated payment processing. But, in a full-service restaurant, server contact is still an essential element in the dining experience. That is, guests need to be escorted to their table, one or more servers must attend to the table to provide tableware, condiments, and menus. The servers notify guests of specials and provide upsell options. The servers must enter orders for each of the guest using their POS terminals and determine coursing of the ordered items. The servers deliver items to the guests that have been prepared by the kitchen according to the determined coursing. The servers monitor their respective tables and collaborate with guests for additions to their orders, and deliver these additions when they are ready. The servers determine when the guests are finished with service. The servers attend to payment of the check for the table, which includes collaborating with the guests to determine how the check will be paid. If the check is to be split, the servers take payment instruments from the guests participating in the split, run corresponding transactions, and close out the order ticket for the table. The servers solicit and enter feedback on the meal and their service. The servers also must be on the alert for walkouts, whether those walkouts are intentional or unintentional.

As one skilled in the art will appreciate, a dining experience, particularly in a full-service restaurant is one in which the guests expect hospitality. Guests want to enjoy eating out. They want to be attended to. They want the opportunity to add to an order, take away from an order, and to do so throughout the dining experience. Guests want to collaborate, often at random times throughout their experience, with their server to provide for a more meaningful and satisfying experience.

Quite frankly, anything that takes away from the quality of service in a dining experience disadvantageous, and these disadvantages are clearly seen by all in the world during periods of disaster or pandemic that require sterilization/sanitization of tableware, kitchen devices, restaurant staff, and virtually everything guests touch. Likewise, during these periods, restaurants take extreme measures to minimize exposure risk for their guests. It is not uncommon today to see restaurants utilize pre-sanitized and packages eating utensils and direct links to their menus online so that guests don't have to touch a physical menu. Yet, current technology still requires servers to take orders, deliver ordered items, monitor their respective tables, and to collaborate with their guests throughout the guests' dining experience. Because of this, restaurant patronage significantly drops during these periods and, because restaurants operate in general on razor thin margins, this latest pandemic has fostered the closure of a substantial number of restaurants worldwide.

The present inventors have observed the need to minimize contact with guests during such periods and have also noted the above limitations of doing so. Therefore, what is needed are methods and systems that provide for contactless, collaborative, full-service restaurant experiences that are improvements over that which has heretofore been provided.

What is also needed are systems and methods for a guest to participate in a contactless dining experience that begins prior to the guest's arrival at a restaurant.

What is additionally needed are systems and methods for multiple guests in a party to participate in a contactless dining experience that begins prior to their arrival at a restaurant.

What is further needed are systems and methods for a guest to participate in a contactless post-dining experience enables the guest to automate payment of their check and to provide feedback on service.

What is moreover needed are systems and methods for a party of guests to participate in a contactless post-dining experience enables the guests to automate division and payment of their check and to provide feedback on service.

### SUMMARY OF THE INVENTION

The present invention, among other applications, is directed to solving the above-noted problems and addresses other problems, disadvantages, and limitations of the prior art.

The present invention provides a superior technique for contactless ordering and fulfillment at a retail establishment. In one embodiment, a method for a contactless order and fulfillment experience in a retail establishment, the method including: via an off-site backend server, registering information corresponding to a guest, initiating the contactless order and fulfillment experience prior to arrival of the guest at the retail establishment, where the initiating includes communicating by the backend server with a smart device corresponding to the guest to enable the guest to pre-order items from a menu and to specify initial coursing instructions for the items, and adding the pre-order items to an electronic order ticket; detecting arrival of the guest at the retail establishment and communicating the arrival to the backend server; via the backend server, continuing the communicating with the smart device to enable the guest to order additional items from the menu and to specify additional coursing instructions for those items, adding the additional items to the electronic order ticket, preparing the pre-order and additional items according to the initial and additional coursing instructions, transmitting notifications to a point-of-sale (POS) terminal in possession of a server assigned to the guest to deliver prepared items to the guest in accordance with the initial and additional coursing instructions; and delivering the prepared items to the guest.

One aspect of the present invention contemplates a method for a contactless order and fulfillment experience in a restaurant, the method including: via an off-site backend server, registering information corresponding to a guest, initiating the contactless order and fulfillment experience prior to arrival of the guest at the restaurant, where the initiating includes communicating by the backend server with a smart device corresponding to the guest to enable the guest to pre-order items from a menu and to specify initial coursing instructions for the items, and adding the pre-order items to an electronic order ticket; detecting arrival of the guest at the restaurant and communicating the arrival to the backend server; via the backend server, continuing the communicating with the smart device to enable the guest to order additional items from the menu and to specify additional coursing instructions for those items, adding the additional items to the electronic order ticket, preparing the pre-order and additional items according to the initial and additional coursing instructions, transmitting notifications to a point-of-sale (POS) terminal in possession of a server assigned to the guest to deliver prepared items to the guest in accordance with the initial and additional coursing instructions; and delivering the prepared items to the guest.

Another aspect of the present invention envisages a system for a contactless order and fulfillment experience in a retail establishment, the system including: an off-site backend server, configured to communicate with a smart device corresponding to a guest, and configured to register information corresponding to the guest, and configured to initiate the contactless order and fulfillment experience prior to arrival of the guest at the retail establishment, and configured to transmit an interactive menu to the smart device and to receive selections of pre-order items and initial coursing instructions from the smart device, and configured to add the pre-order items to an electronic order ticket; a host point-of-sale (POS) terminal, coupled to the off-site backend server via an internet gateway, configured to notify the backend server that the guest has arrived at the retail establishment; and the backend server, configured to continue to communicate with the smart device, and configured to and to receive selections of additional items and additional coursing instructions from the smart device, and configured to add the additional items to the electronic order ticket, and configured to transmit notifications to a mobile point-of-sale (POS) terminal in possession of a server assigned to the guest to deliver prepared items to the guest according to the initial and additional coursing instructions; whereby the server is prompted to deliver the prepared items to the guest.

### BRIEF DESCRIPTION OF THE DRAWINGS

These and other objects, features, and advantages of the present invention will become better understood with regard to the following description, and accompanying drawings where:

FIG. 1 is a block diagram illustrating a contactless order and fulfillment system according to the present invention;

FIG. 2 is a block diagram depicting a backend server according to the present invention, such as may be employed in the system of FIG. 1;

FIG. 3 is a block diagram featuring a point-of-sale (POS) terminal according to the present invention, such as may be employed in the system of FIG. 1;

FIG. 4 is a flow diagram showing a method according to the present invention for contactless order and fulfillment;

FIG. 5 is a diagram illustrating an exemplary guest device personalized ordering display according to the present invention;

FIG. 6 is a diagram detailing an exemplary server device display according to the present invention;

FIG. 7 is a diagram showing an exemplary guest device payment authorization display according to the present invention; and

FIG. 8 is diagram illustrating an exemplary guest itemized payment display according to the present invention.

### DETAILED DESCRIPTION

Exemplary and illustrative embodiments of the invention are described below. It should be understood at the outset that although exemplary embodiments are illustrated in the figures and described below, the principles of the present disclosure may be implemented using any number of techniques, whether currently known or not. In the interest of clarity, not all features of an actual implementation are described in this specification, for those skilled in the art will appreciate that in the development of any such actual embodiment, numerous implementation specific decisions are made to achieve specific goals, such as compliance with system-related and business-related constraints, which vary from one implementation to another. Furthermore, it will be appreciated that such a development effort might be complex and time-consuming, but would nevertheless be a routine undertaking for those of ordinary skill in the art having the benefit of this disclosure. Various modifications to the preferred embodiment will be apparent to those skilled in the art, and the general principles defined herein may be applied to other embodiments. Therefore, the present invention is not intended to be limited to the particular embodiments shown and described herein, but is to be accorded the widest scope consistent with the principles and novel features herein disclosed.

The present invention will now be described with reference to the attached figures. Various structures, systems, and devices are schematically depicted in the drawings for purposes of explanation only and so as to not obscure the present invention with details that are well known to those skilled in the art. Nevertheless, the attached drawings are included to describe and explain illustrative examples of the present invention. Unless otherwise specifically noted, articles depicted in the drawings are not necessarily drawn to scale.

The words and phrases used herein should be understood and interpreted to have a meaning consistent with the understanding of those words and phrases by those skilled in the relevant art. No special definition of a term or phrase (i.e., a definition that is different from the ordinary and customary meaning as understood by those skilled in the art) is intended to be implied by consistent usage of the term or phrase herein. To the extent that a term or phrase is intended to have a special meaning (i.e., a meaning other than that understood by skilled artisans) such a special definition will be expressly set forth in the specification in a definitional manner that directly and unequivocally provides the special definition for the term or phrase. As used in this disclosure, “each” refers to each member of a set, each member of a subset, each member of a group, each member of a portion, each member of a part, etc.

Applicants note that unless the words “means for” or “step for” are explicitly used in a particular claim, it is not intended that any of the appended claims or claim elements are recited in such a manner as to invoke 35 U.S.C. § 112(f).

### Definitions

Central Processing Unit (CPU): The electronic circuits (i.e., “hardware”) that execute the instructions of a computer program (also known as a “computer application,” “application,” “application program,” “app,” “computer program,” or “program”) by performing operations on data, where the operations may include arithmetic operations, logical operations, or input/output operations. A CPU may also be referred to as a “processor.”

Module: As used herein, the term “module” may refer to, be part of, or include an application specific integrated circuit (ASIC), an electronic circuit, a processor (shared, dedicated, or group) and/or memory (shared, dedicated, or group) that execute one or more computer programs, a combinational logic circuit, and/or other suitable components that provide the described functionality.

Microprocessor: An electronic device that functions as a CPU on a single integrated circuit. A microprocessor receives digital data as input, processes the data according to instructions fetched from a memory (either on-die or off-die), and generates results of operations prescribed by the instructions as output. A general-purpose microprocessor may be employed in a desktop, mobile, or tablet computer, and is employed for uses such as computation, text editing, multimedia display, and Internet browsing. A microprocessor may also be disposed in an embedded system to control a wide variety of devices including appliances, mobile telephones, smart phones, and industrial control devices.

Thin client: A thin client is an application program executing on a computing device (e.g., desktop computer, laptop computer, tablet computer, smartphone, etc.) that runs from resources stored on a central server instead of a localized hard drive. Thin clients work by connecting remotely to a server-based computing environment where most applications, sensitive data, and memory, are stored.

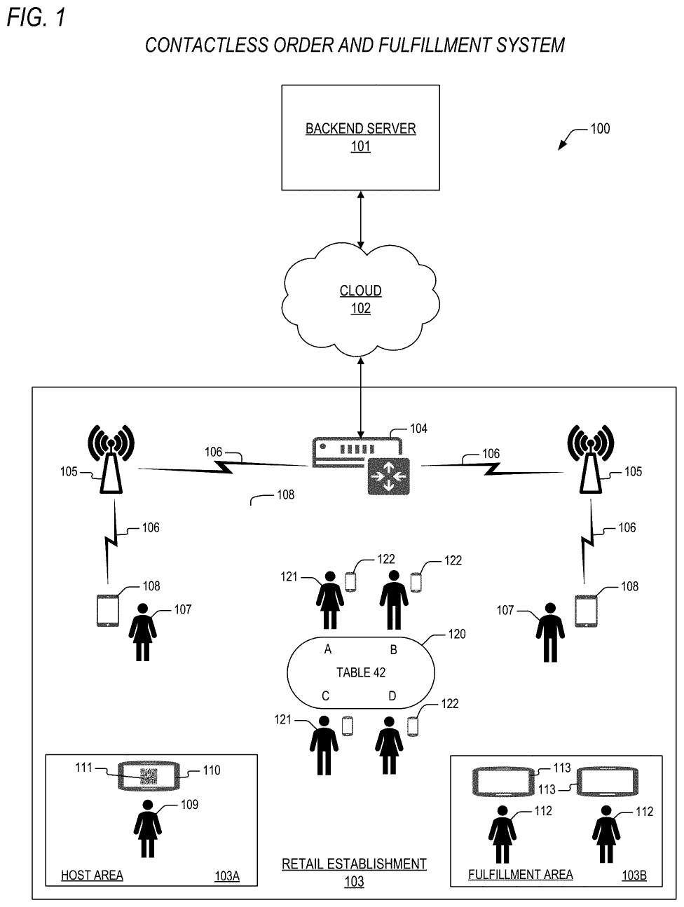

In view of the above background discussion on how ordering and fulfillment of orders are currently performed retail establishments, a discussion of the present invention will be provided with reference to FIGS. 1-8. The present invention overcomes the problems associated with present-day techniques by providing methods and apparatus whereby retail establishment staff may handoff ordering of items to one or more guests at a designated location, while prompting retail establishment staff to provide a level of service and fulfillment that minimizes direct contact and considerably improves the overall experience of the one or more guest, thus providing a current transaction from a point-of-sale (POS) terminal to a guest device to allow for concurrent display of the transaction on both the POS terminal and the guest device, and to allow a guest to provide a tip amount, an optional payment method, and service feedback that alerts management to problems, thus providing significant improvements in this field of technology.

Referring to FIG. 1, a block diagram is presented illustrating a contactless order and fulfillment system 100 according to the present invention. The system 100 includes a backend server 101 that is operationally coupled to an internet gateway 104 that is disposed within a retail establishment 103. The backend server 101 is not disposed within the establishment 103 and may be disposed within an off-site network operations center or other location. The backend server 101 is coupled to the gateway 104 via the internet cloud 102 using a combination of conventional wired and wireless links that allow for communications between devices over the internet cloud 102. The conventional wired links may include, but are not limited to, Ethernet, cable, fiber optic, and digital subscriber line (DSL). As part of the network path to and through the cloud 102, providers of internet connectivity (e.g., ISPs, backbone, etc.) may employ wireless technologies from point to point as well.

The gateway 104 provides for coupling of the backend server 101 to one or more point-of-sale (POS) terminals 108, 110, 113 and to one or more smart devices 122 corresponding to one or more guests 121 in the retail establishment 103 via one or more access points 105. In some embodiments, one or more of the one or more smart devices 121 may be coupled directly to the backend server 101 via cellular links (not shown) through the internet cloud 102. The access points 105 may be coupled to the gateway 106 via wired or wireless links 106. The wired links 106 may include, but are not limited to, Ethernet networks, local area networks, and etc. The wireless links 106 may include, but are not limited to, Wi-Fi, Bluetooth, near field communications, infrared links, IEEE 802.15.4, Zigbee radio links, and cellular based links (e.g., 3G, 4G, LTE, 5G), or a combination of the noted links. The POS terminals 108, 110, 113 may be configured differently to comport with intended function (e.g., seating, order entry, order fulfillment, payment processing, owner engagement, order feedback, etc.), or they may be configured similarly.

To clearly teach the present invention, three types of POS terminals 108, 110, 113 are depicted as part of the system 100: a fixed host POS terminal 110 attended by a retail establishment host 109 in a host area 103A, one or more fixed fulfillment POS terminals 113 attended by one or more retail establishment fulfillment staff 112 in a fulfillment area 103B, and one or more mobile POS terminals 108 attended by corresponding one or more servers 107. Though the fixed POS terminals 110, 113 may being coupled wirelessly to the gateway 104 via the wireless links 106 or they may alternatively be coupled to the gateway 104 via the wired links 106. The mobile POS terminals 108 may be employed by the servers 107 in multiple locations within the establishment 103 to deliver items ordered by the one or more guests 121, and which have been prepared by fulfillment staff 112 according to a coursing timeline, as will be described in more detail below. Though the general functions of the two POS terminals 108, 110, 113 are substantially similar, the primary difference between their mode of use is that typically a guest 121 will initially enter into the contactless order and fulfillment experience by scanning a Quick Response (QR) code 111 displayed on the host POS terminal 110 that hands off essential functions (e.g., display of menus, ordering, coursing instructions, payment terms and authorization, tipping, payment for items ordered and fulfilled, feedback, loyalty initiatives, walkout preclusion and resolution, etc.) of the contactless order and fulfillment experience to the guest's smart device 108. Once a guest 121 has entered into the contactless experience, he/she may be located at a designated location 120 along with other guests 121 within a party. The guests 121 may be assigned a seat A-D at the location 120 (Table 42), and one or more servers 107 may be assigned to provide service and fulfillment of items ordered by the guests 121, as prompted by notification icons on the server's corresponding mobile POS terminals 108 that are transmitted by the backend server 101.

The present inventors note that, although scanning a QR code 111 may be employed to initiate contactless experience, other mechanisms for entering are contemplated. For instance, a guest 121 can initialize at any point in their dining experience. Prior to a guest's arrival, pre-order items (associated with the table 120 at which they will be seated) may be prepared in advance of their arrival, the guest 121 can then enter and add to the order by scanning a QR code on the table (not shown), by receiving an invite link via native mobile share (or text) or by scanning the QR code 111 at the host stand. The order can be “initiated” by either the guest 121 or the server 107 or host 109 at any point.

Preferably, each of the guests 121 are in possession of a corresponding smart device 122, and have entered into the contactless experience as described above. The smart devices may comprise, but are not limited to, Android phones, iPhones, Android tablets, iPads, and equivalent smart devices that are well known in the art. The smart devices 122 may be executing a proprietary application program that corresponds to the retail establishment and that allows the guests 121 to perform the essential functions noted above. For guests 121 that do not possess a corresponding smart device 122, the system 100 is configured to enable one or more guests 121 at the designated location 120 to order items, provide coursing instructions, page the servers location 120 to order items, provide coursing instructions, page servers (i.e., wait staff) 107, provide payments, etc. on their respective smart devices 122 for those guests 121 without smart devices 122. The system 100 is further configured to enable one or more of the servers (“wait staff) 107 assigned to the designated location 120 to order items, provide coursing instructions, provide payments, etc. on their respective POS terminals 122 for those guests 121 without smart devices 122.

One embodiment of the present invention contemplates initialization of the contactless experience when a guest 122 makes a reservation or joins a waitlist for a party of guests 121 via the proprietary application. Another embodiment envisages initialization of the contactless experience when a guest 122 makes a reservation or joins a waitlist for a party of guests 122 via a 3^{rd} party application such as, but not limited to, OPENTABLE®, RESY®, NEXTME®, and YELP®. Accordingly, the proprietary application or 3^{rd} party application may transmit details of the guest identity and reservation or waitlist details to the backend server 101, and the backend server 101 may communicate with the corresponding guest device 122 to provide a hyperlink that, when selected, takes the guest device to the proprietary application (if installed on the corresponding client device 122, a thin client web service, or a small part of the proprietary application, the content of which is controlled by the backend server 101. The small part of the proprietary application may be installed on the corresponding guest device by initiation of iPhone App Clip, Android Instant Apps, or the like when the guest device 122 selects the hyperlink or initiates the contactless experience in the retail establishment by scanning the QR code 111. The backend server 101 may further enable the guest device 122 to send the hyperlink to other guest devices 122 in the party of guests 121 to enable the other guests 121 in the party of guests 121 to enter into the contactless experience. The present inventors note that joining a waitlist or making a reservation as an entry point into the contactless experience is differentiated from the use of app clips in that installation the app clip on the smart device 122 allows access to the native level and enables the system to send reminders, track location, and etc. without requiring installation of a proprietary application. The present inventors further note that a guest may browse and order items while waiting on a waitlist or reservation.

To provide improved contactless service, guests 121 are preferably contacted by the backend server 101 on behalf of the retail establishment 103 to provide identifying information such as, but not limited to, name, email address, phone number; to install the proprietary application; to enable text messaging and/or push notifications from the backend server 101, to register one or more payment instruments (e.g., credit/debit cards, Apple Pay, Android Pay, loyalty and gift cards, etc.). Once this information is provided, the system may further be enabled to refer to the guests 121 by name and may additionally obtain loyalty information, historical purchases, and historical preferences which are stored on the backend server 101 for the guests' previous visits to the retail establishment 103 or to other like establishments that participate in a POS subscription service corresponding to the system. The backend server 101 may further query social media sites using the provided name, phone number, or email address to obtain other information that may be employed to tailor menus and to provide effective upsell opportunities.

In one embodiment, the retail establishment 103 comprises a restaurant 103 that participates in a POS subscription service administered by Toast, Inc., where the loyalty information, historical purchases, and historical preferences may correspond to previous visits to one or more of over 30,000 restaurants.

To more clearly teach relevant aspects of the present invention, elements of the system 100 will be referred to in terms of a restaurant contactless dining experience that may employ a host 109 attending a host POS terminal 110, kitchen staff 112 attending to kitchen display terminals 113, and servers 107 using mobile POS terminals 108 to attend to a party of guests 121 in seats A-D at a table 120 in the restaurant. Though a restaurant setting is employed going forward, the present inventors note that elements of the present invention may be equally employed in other hospitality settings as well (e.g., bars, food truck parklets, theaters, conference centers, concerts, etc.).

It is an objective of the present invention to provide a contactless restaurant experience that minimizes unnecessary contact between the guests 121, servers 107, restaurant staff 109, and kitchen personnel 112. Accordingly, in operation, one or more of the guests 121 in the party may enter into the contactless experience, as noted above, prior to arrival at the restaurant 103, and may be provided with a personalized menu that they may order from. The backend server 101 may employ the loyalty information and historical purchases/preferences stored therein to tailor the personalized menu for each guest 121. For example, a guest 121 that is known by the system 100 to be vegan may be presented with a menu on their smart device 122 having vegan-only options. Once the first guest 121 in the party joins the contactless experience, the backend server 101 opens an order ticket corresponding to the party of guests 121, assigns the party of guests 121 to a table 120, and designates servers 107 for the table 120 at the appropriate time of arrival and check-in. The backend server 101 may further reassign the party to other available tables 120 and servers 107 as a function of restaurant workload and throughput.

The present invention contemplates several techniques for determining when a guest 121 arrives at the restaurant 103 that include the guest scanning the QR code 111 (or bar code) on their smart device 122, selecting an “I'm at the restaurant” hyperlink presented via the proprietary application, thin client, app clip, email, text message, push notification, social media (e.g., Facebook, Twitter, etc.) message, or other form of electronic communication to the guest's smart device 122. Detection of arrival may further employ NFC, Wi-Fi triangulation, or Bluetooth Low Energy (BLE) beacons to detect the guest's smart device 122. If a guest 121 has registered a photo of themselves with the backend server 101, arrival detection may utilize cameras disposed at the restaurant entrance along with facial recognition techniques. It is a feature of the present invention that the POS terminals 108, 110, 113 communicate state changes for all open order tickets to the off-site backend server 101 via the internet cloud and that the backend server 101 coordinates messaging of prompts to the server devices 108, the host device 110, and the kitchen devices 113 to facilitate timing of all courses. These state changes include, but are not limited to guest number X or party Y pre-arrival orders, guest number X of party Y arrival at restaurant, guest number X of party Y page to server 107, guest number X of party Y item order and coursing designation, guest number X of party Y additional orders and coursing designation, guest number X of party Y completion of service, guest number X of party Y payment authorization (e.g., pay for table, split with other guests, pay only for ordered items, pay other amount, etc.), guest number X of party Y payment instrument selection, guest number X of party Y tip amount, guest number X of party Y electronic signature, guest number X of party Y processed payment, guest number X of party Y walkout timer timeout for ticket closeout, guest number X of party Y partial ticket completion, guest number X of party Y feedback to restaurant 103, guest number X of party Y tailored loyalty initiatives sent, and order ticket completion for party Y.

One embodiment of the present invention contemplates that order statuses for all orders in the restaurant 103 are transmitted by the backend server 101 to all mobile POS terminals 108 in the restaurant 103 so that any server 107 and corresponding POS terminal 108 may be dynamically assigned to provide service to the table 120.

Guests 121 that have entered the restaurant 103 may be escorted to their table 120 or may wait until all guests 121 in the party have arrived to be escorted to their table 120. Any items that a guest 121 has ordered and designated “upon arrival” may be provided by the servers 107 at the door, at a bar (while waiting on their table 120), or at the table 120 according to guest preference.

Once seated at their designated places A-D, designated servers 107 are prompted by the backend server 101 on their respective mobile POS terminals 108 to provide initial service amenities (e.g., water, silverware, condiments, etc.) along with pre-ordered items that are designated for “upon arrival.” Upon greeting the guests 121, the servers 107 may leave the table 120 so the guests 121 may order items and provide coursing instructions for those items on their smart devices. The ordered items and coursing instructions are transmitted to the backend server 101 from the respective smart devices 122. Accordingly, the backend server 101 may transmit messages to appropriate kitchen display devices 113 to initiate preparation of ordered items corresponding coursing instructions such as “ASAP.” For example, a kitchen display device 113 corresponding to a bar station may receive ASAP drink order instructions from the backend server 101. A kitchen display device 113 corresponding to an appetizer station may receive ASAP appetized order instructions from the backend server 101. A kitchen display device 113 corresponding to a dessert station may receive ASAP dessert order instructions from the backend server 101. The kitchen display devices 113 may message the backend server 101 when order items are ready for service to the table 120, and the backend server 101 may message the designated mobile POS devices 108 that the ordered items are ready for delivery to the table. In one embodiment, the backend server may message a kitchen display device 113 at an expediter station with status of ordered items from order prep kitchen display devices 113 to allow the expediter station to view progress of a course corresponding to the open order ticket and the expediter station may message the backend server 101 that a course is ready for delivery to the table 120. The backend server 101 may, in turn, message the mobile POS terminals 108 to deliver items within the course to the table 120. In another embodiment, the backend server 101 is configured to note statuses of all items within a course and operate as a virtual expediting station to communicate with the kitchen display stations 113 and to message the mobile terminals 108 that items within a course have been fulfilled and are ready for table service. Though the above describes that servers 107 leave the table 120 so guests 121 can begin ordering,” the present inventors note that both guests 121 and servers 107 can add items to the same electronic order ticket so as to not sacrifice hospitality, thereby increasing order volume and guest satisfaction.

Throughout the contactless dining experience, the guests 121 may add items to the open order ticket via their smart devices 122 and the backend server 101, kitchen display devices 113, and mobile devices 108 operate to prompt for preparation and delivery of the additional items to the guests 121 at the table 120 according to coursing instructions provided by the guests 121. The guests 121 may further page their designated server 107 to provide further instructions or feedback via their smart devices 122. The pages are transmitted from the smart devices 122 to the backend server 101 and the backend server 101 messages the mobile POS terminals 108 to prompt their servers 107 to attend to the table 120.

Each guest 121 may indicate that they have finished their respective meal via their respective smart device. These status changes are transmitted to the backend server 101 and the backend server 101 prompts server 107 via their mobile POS devices 108 to begin table clearance. Once the last guest 121 in the party has indicated they have finished, the backend server 101 may transmit payment authorization messages to the smart devices 122 that manipulate icons and fields on displays of the smart devices 122 to enable the guests 121 to designate how the open order ticket will be divided. The smart devices 122 transmit messages to the backend server 101 providing payment instructions for the open ticket. Once sufficient instructions to begin payment processing are received by the backend server 101, messages are sent to appropriate smart devices 122 for signature and authorization to use a stored payment instrument. For example, if a guest 121 selects “I'll pay for the whole table,” then the backend server 101 would transmit details of the entire check to that guest. For guests 121 that have elected to split the check, then the backend server 101 would transmit details of corresponding splits of the checks to those guests 121. If conflicting payment instructions are received by the backend server 101, the backend server 101 messages the mobile POS terminals 108 with those details to prompt the servers 107 to resolve the conflicts at the table 120.

Once the paying guests 121 have authorized use of their respective payment instruments, the backend server 101 processes each transaction that was authorized. Upon successful completion of the transactions, the backend server 101 may message the smart devices 122 to provide a receipt, to indicate that they have paid and may exit, to solicit feedback on the meal, and to provide loyalty incentives such as, but not limited to loyalty points, future discounts at the restaurant, and future discounts at any restaurant that are part of the subscription service provided for by the system 100. The backend server 101 may also message the mobile POS terminals 108 to inform the servers that the order ticket is closed and may further include feedback provided by the guests, tip tally for the evening, and other information that is useful to the servers 107.

The system 100 may further be configured to detect walkouts or those guests 121 that left the restaurant and simply forgot to pay. Detection may be performed by any of the above-noted automated techniques for detecting entry into the restaurant or may utilize a walkout timer set that is based on when a guest provided a first order. In one embodiment, the walkout timer is set to 4 hours from first order. Other embodiments are contemplated. Upon walkout detection, the backend server 101 may message the smart device 108 corresponding to the guest 121 that walked, providing links for payment. Alternatively, the backend server 101 may message the smart device 108 that payment plus a surcharge was made to a stored payment instrument in accordance with a pre-existing walkout agreement with the guest.

Advantageously, the system 100 according to the present invention provides technological improvements to this field of the art by enabling a retail establishment 103 to provide an order, fulfillment, and payment experience to guests 121 in a party of guests 121 that minimizes contact of between the guests 121 and retail establishment staff 107, 109, 112 while at the same time providing service and fulfillment in accordance with coursing instructions comparable to that heretofore provided for in those retail establishments that allow more contact between the guests 121 and staff 107, 109, 112. In addition, because servers 107 according to the present invention are not required to attend to their designated guests 121 except upon page by the guests 121 or service prompts provided by the backend server 101, the servers 107 may be assigned to additional parties of guests 121, thereby reducing the cost of personnel in the retail establishment over that which has heretofore been provided.

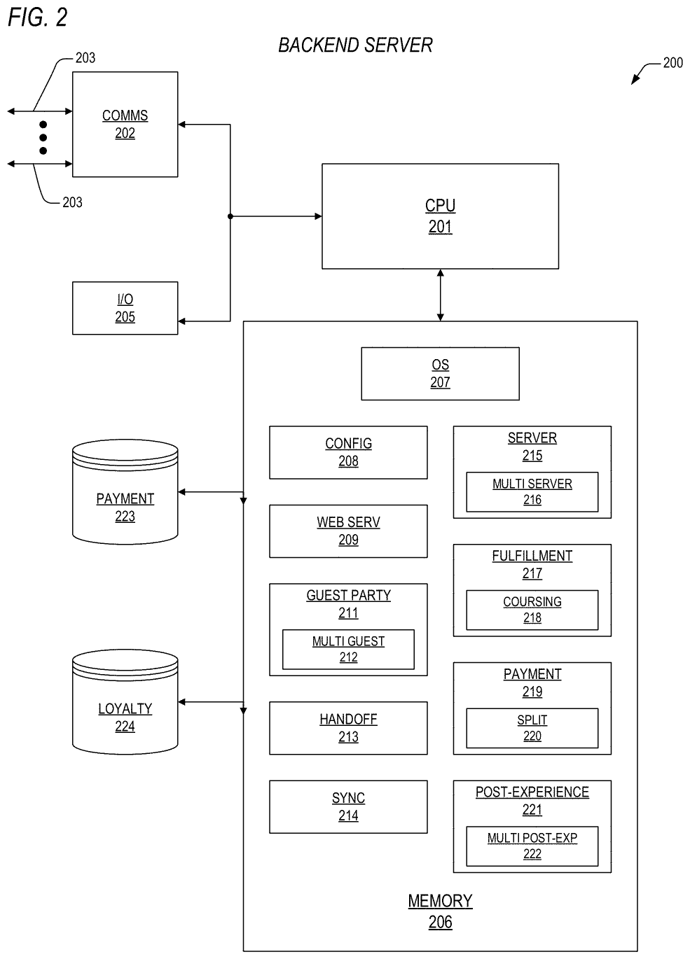

Turning to FIG. 2, a block diagram is presented depicting a backend server 200 according to the present invention, such as may be employed in the system 100 of FIG. 1. The backend server 200 may be embodied as a central processing unit (CPU) 201 that is coupled to a memory 206 having both transitory and non-transitory memory components therein. The CPU 201 is also coupled to a communications circuit 202 that coupled the backend server 200 to the Internet cloud via one or more wired and/or wireless links 203 as are discussed above. The backend server 200 may also comprise input/output circuits 205 that include, but are not limited to, data entry and display devices (e.g., keyboards, monitors, touchpads, etc.). The memory 206 may be coupled to a payment database 223 and to a loyalty database 224. In one embodiment, the payment database 223 and loyalty database 224 are disposed in the same location as the memory 206. In another embodiment, the payment database 223 and loyalty database 224 are not disposed in the same location as the memory 206 and are accessed via messages transmitted and received over the links 203 rather than by direct connection as shown in the diagram.

The memory 206 may include an operating system 207 such as, but not limited to, Microsoft Windows, Mac OS, Unix, and Linux, where the operating system 207 is configured to manage execution by the CPU 201 of program instructions that are part of components of one or more application programs. In one embodiment, a single application program comprises a plurality of modules (or “code segments”) 208-222 resident in the memory 206 and identified as a configuration process (CONFIG) 208, a web services process (WEB SERV) 209, a guest party process (GUEST PARTY) 211, a handoff process (HANDOFF) 213, a synchronization process (SYNC) 214, a server process (SERVER) 215, a fulfillment process (FULFILLMENT) 217, a payment process (PAYMENT) 219, and a post-experience process (POST-EXPERIENCE) 221. GUEST PARTY 211 includes a multiple guest process (MULTI GUEST) 212. SERVER 215 includes a multiple server process (MULTI SERVER) 216. FULFILLMENT 217 includes a coursing process (COURSING) 218. PAYMENT 219 includes a check splitting process (SPLIT) 220. POST-EXPERIENCE 221 includes a multiple post-experience process (MULTI POST-EXP) 222.

Operationally, the backend server 200 may execute one or more of the code segments 208-222 as required to communicate with a proprietary application program that provides for reservations, waitlists, check-in, and ordering for all restaurants that are participate in a subscription service corresponding to the system 100 of FIG. 1. The backend server 200 may also execute one or more of the code segments 208-222 as required to communicate with 3^{rd} party reservation/waitlist application programs as noted above. The backend server 200 may further execute one or more of the code segments 208-222 as required to communicate with social media applications to obtain information associated with one or more guests who have made a reservation at a restaurant, or who are on a waitlist for the restaurant, or who have entered the restaurant, as detected by scanning a QR code displayed by host staff, or by any of the above noted entry detection mechanisms. The backend server 200 may additionally execute one or more of the code segments 208-222 as required to communicate with host POS terminals to enter the guests into a contactless order and fulfillment experience as they are detected upon entry into the restaurant. The backend server 200 may further execute one or more of the code segments 208-222 as required to communicate with smart devices corresponding to guests in a party to provide for personalized menus, ordering, coursing, payment terms, payment authorization, and feedback. The backend server 200 may additionally execute one or more of the code segments 208-222 as required to communicate with kitchen display devices in the restaurant to initiate and coordinate fulfillment of items ordered by the guests in accordance with coursing instructions transmitted by the guests. The backend server 200 may moreover execute one or more of the code segments 208-222 as required to communicate with mobile POS terminals to prompt servers to deliver ordered items to the guests that have been fulfilled by the kitchen according to coursing instructions received from the guests, to page servers to the table based upon communications received from the guest's smart devices, to page servers to resolve payment terms conflicts, to solicit guest feedback, and to perform other tasks commensurate with the level of service experienced in a full-service restaurant.

The payment database 223 comprises a plurality of payment records that each link one or more payment instruments to a particular smart device, where the smart device has registered guest information with the subscription server as described above along with one or more payment instruments. The guest information may comprise credit card numbers and guest name. Once registered, the guest information is encoded into a payment record that additionally includes the one or more payment instruments along with an identifier for the linked smart device. Accordingly, the backend server 200 may transmit messages at the end of a meal to smart devices corresponding to guests in the party that allows them to select from the one or more stored payment instruments for payment of all or part of the check for the party.

The loyalty token database 217 comprises a plurality of loyalty records that each link a loyalty account identifier (“loyalty token”) to one or more fields of contact information for a guest who has created a loyalty account with the establishment either via a web browser coupled to the backend server 200, a web browser executing on a guest's smart device, directly from the proprietary application executing on their smart device, or from a 3^{rd} party reservation/waitlist service. The loyalty records may include one or more of the following fields: smart device identification, guest name, guest email address, guest number for text messages, and other identifiers for direct messaging (e.g., Facebook Messenger). In one embodiment, during registration a guest may opt to allow push notifications to their smart device from the backend server 200.

The CPU 201 may execute CONFIG 208 to record the configuration of each of the POS terminals within the restaurant and other restaurants that are part of the subscription service. As noted above, the POS terminals may be configured as mobile POS terminals, host POS terminal, and kitchen display terminals, and my additionally be configured in a fixed or mobile configuration, as a kiosk, and CONFIG 208 may further designate the POS terminals as being wired or wireless.

WEB SERV 209 may be executed to format and transmit data to guest smart devices via the links 203 such as personalized menus and payment screens and to receive data from the guest smart devices such as ordered items, coursing instructions, and payment authorizations. WEB SERV 209 may further provide substantially similar web page interfaces for guests to provide information on devices other than their smart devices such as desktop or laptop computers.

GUEST PARTY 211 executes to retrieve loyalty information for each guest in a party from the loyalty database 224, to generate personalized menus for each of the guests, to receive ordered items and coursing instructions from each of the guests, to receive pages from each of the guests, to receive payment authorizations from each of the guests, and to perform all of the functions required to format and decode data for communication with all guest devices which is transmitted and received by COMMS 202. Data may be transmitted/received directly from the guest devices when they are executing a proprietary application program thereon or when they are executing an app clip of the proprietary application program. Data may be transmitted/received indirectly through WEB SERV 209 when the guest devices utilize a web browser on their smart device to enter and participate in the contactless experience. MULTI GUEST 212 may execute to configure a party comprising multiple guests in order to open and maintain a single order ticket for each party and to aggregate items ordered by each of the guests into courses (as designated by each guest). These ordered items by course are communicated to SERVER 215 and FULFILLMENT 217. MULTI GUEST 212 may additional group ordered items into a course that are ordered within a prescribed time period. In one embodiment, the time period comprises 15 minutes. Other time periods are contemplated. A primary function of GUEST PARTY 211 is to serve as virtual wait staff, by keeping track of the times items are ordered; how long the table has been idle; providing notifications to FULFILLMENT 217 to start preparation of a course, receiving notifications from FULFILLMENT 217 of preparation progress and status for items within a course; providing summaries and updates of preparation and status to the guest devices, receiving pages from guest devices for service and communicating these pages to SERVER 215; receiving payment authorization from the guest devices an notifying both SERVER 215 and PAYMENT 219; receiving ticket completion from PAYMENT 219 and notifying POST-EXPERIENCE 221; receiving personalized loyalty content from POST-EXPERIENCE 221 and communicating the loyalty content to the guest devices; and receiving feedback from the guest devices, storing the feedback in the loyalty database 224, and notifying SERVER 215 of payments, tip amounts, and feedback received. GUEST PARTY 211 may further comprise a walkout timer for each guest as noted above, and may further operate in conjunction with PAYMENT 219 to process transactions for those guests which have not paid during a walkout time period.

HANDOFF 213 executes to establish communications with guest devices as they enter into the contactless experience prior to arrival at the restaurant and to receive indication from the host POS terminal that guests in a party have arrived at the restaurant. HANDOFF 213 may further communicate with the host POS terminal to coordinate wait lists and reservations, to assign parties of guests to tables, and to optimize flow of guests and staff during busy times.

SYNC 214 executes to receive status updates on order tickets within the restaurant as noted above that are received from guest devices within the parties in the restaurant, and to transmit these status updates for all order tickets within the restaurant to each and every mobile POS terminal, thereby enabling any server (and corresponding mobile POS terminal) to be reassigned for service at any given table.

SERVER 215 executes to receive communications noted above from GUEST PARTY 211 and SYNC 214, and also to receive pages from FULFILLMENT 217 to deliver items ordered within a course to the table, pages from PAYMENT 219 indicating conflicts in payment instructions at a table, and notifications from PAYMENT 219 indicated ticket completion. SERVER 215 includes a mapping of servers and mobile POS terminals to respective tables for which they have been assigned. Accordingly, pages from GUEST PARTY 211, FULFILLMENT 217, and PAYMENT 219 are routed only to those mobile POS terminals that are assigned to those respective tables. MULTI SERVER 216 executes to coordinate pages between multiple POS terminals that have been assigned to a single table to minimize delivery times for the table and to efficiently utilize carry capacity for each of the servers assigned to the table.

FULFILLMENT 217 executes to receive ordered items and coursing instructions from GUEST PARTY 211, to distribute those ordered items to appropriate kitchen display terminals (e.g., bar, appetizer, meat station, sides station, dessert station, etc.) and to provide preparation progress and status to GUEST PARTY 211, to communicate with the kitchen display terminals and optional expeditor display terminal to detect preparation completion for a course, and to page appropriate servers via SERVER 215 to prepared items in the course to the table. COURSING 218 executes to manage all ordered items within each course of the meal.

PAYMENT 219 executes to perform payment functions after the meal is complete such as communicating with GUEST PARTY 211 to obtain how an open ticket will be paid as instructed by each guest in the party, which payment instruments are to be used as payment, authorization of payment by guests, and confirmation of payment. PAYMENT 219 may also retrieve payment records from the payment database 223 to obtain the payment instruments for communication with GUEST PARTY 211, and may also process transactions with credit card processors via messages transmitted over the links 203. SPLIT 220 executes to coordinate amounts, tips, and ticket splits for multiple guests corresponding to an order ticket.

POST-EXPERIENCE 221 executes to access and update the loyalty database 224 for guests that participate in a loyalty program for restaurants in the subscription service, to communicate loyalty initiatives as noted above to GUEST PARTY 211 for transmission to the guest devices, and receive guest feedback from GUEST PARTY 211. MULTI POST-EXP 222 executes to coordinate loyalty initiatives for guests within a party and to aggregate feedback from guests within the party for storage in the loyalty database 224 and for notification of servers and management (via SERVER 215).

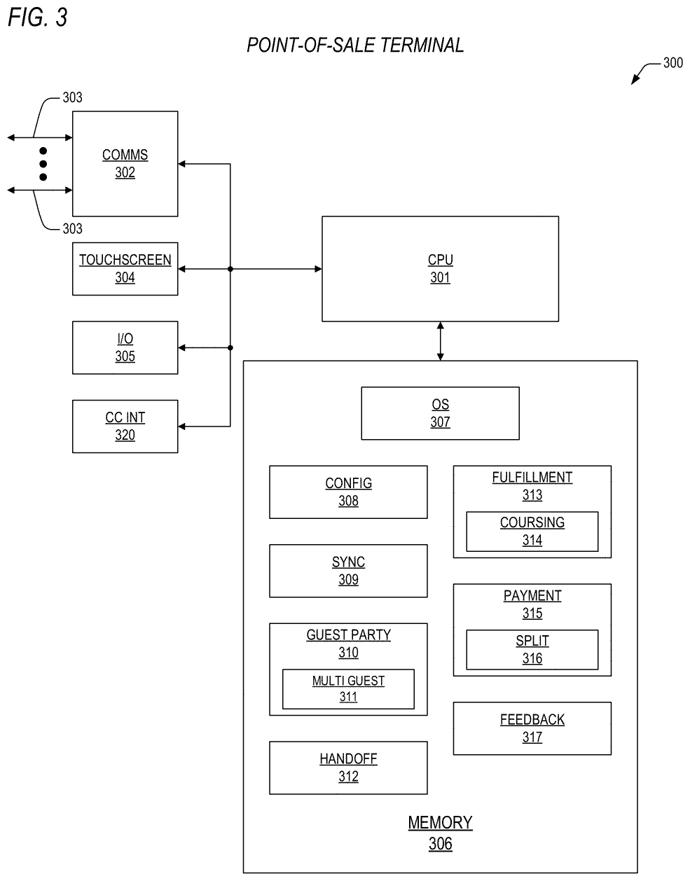

Now referring to FIG. 3, a block diagram is presented featuring a point-of-sale terminal 300 according to the present invention, such as may be employed in the system of FIG. 1. The terminal 300 may be embodied as either a fixed terminal 107 or a mobile terminal 108 as is discussed above, and may be configured to comports with function such as, but not limited to, server POS terminal, kiosk terminal, host station terminal, kitchen display terminal, or expeditor terminal, where the differences being generally in the size of the terminal 300 and connection (wired or wireless) to the gateway 104. Typically, a fixed terminal 107 is larger in size than a mobile terminal 108 and the mobile terminal 108 is sized so that it can be easily carried by wait staff. A kitchen display terminal and expeditor terminal may be much larger in size to allow kitchen staff to see items ordered from their respective preparation stations.

The terminal 300 may be embodied as a central processing unit (CPU) 301 that is coupled to a memory 306 having both transitory and non-transitory memory components therein. The CPU 301 is also coupled to a communications circuit 302 that couples the terminal 300 to a gateway 104 within the establishment via one or more wired and/or wireless links 303 as are discussed above. Through these links 303, the terminal 300, along with other terminals in the establishment, may directly communicate with the backend server 200. No on-site local server is required to perform any point-of-sale function within the establishment, as all synchronization functions are performed through messages exchanged between the backend server 200 and the terminal 300. The terminal 300 may comprise a touchscreen 304 that allows for order entry, display of menu items, and related functions for those guests that don't have a smart device. The touchscreen 300 may be employed to display pages from guests and from the kitchen, as provided by respective processes in the server 200. The terminal 300 may also comprise input/output circuits 205 that include, but are not limited to, data entry and display devices (e.g., keyboards, monitors, touchpads, scanners, cameras, printers, etc.). The terminal 300 may further comprise a card entry interface 320 that staff may employ to enter payment instrument data into the system for those guests who have not pre-registered a payment instrument. In one embodiment, the interface 320 comprises a conventional card reader that may provide for entry of card data via magnetic strip swipe, EMV chip reading (“dip”), or reading of encoded data via near field communications (“tap”). The interface 320 may be capable of one or more of the aforementioned mechanisms for reading card data. In one embodiment, the credit card interface 320 may be integrated into the same housing as the touchscreen 304. In one embodiment, the input/output circuits may be employed to identify indirect transaction authorization mechanisms that are not readable by the card reader 320.

The memory 306 may include an operating system 307 such as, but not limited to, Microsoft Windows, Mac OS, Unix, and Linux, where the operating system 307 is configured to manage execution by the CPU 301 of program instructions that are part of components of one or more application programs. In one embodiment, a single application program comprises a plurality of code segments 308-317 resident in the memory 306 and identified as a configuration process (CONFIG) 308, a synchronization process (SYNC) 309, a guest party process (GUEST PARTY) 310, a handoff process (HANDOFF) 312, a fulfillment process (FULFILLMENT) 313, a payment process (PAYMENT) 315, and a feedback process (FEEDBACK) 314. Other code segments (not shown) may be provided to perform other point-of-sale functions by the terminal 300 (e.g., printing of receipts, entry of gift cards, etc.) which are not discussed herein in order to clearly teach aspects of the present invention. GUEST PARTY 310 includes a multiple guest component (MULTI GUEST) 311. FULFILLMENT 313 includes a coursing component (COURSING 314). PAYMENT 315 includes a check splitting component (SPLIT) 316.

Operationally, the terminal 300 may execute one or more of the code segments 308-317 as required to detect/determine entry of guests into the restaurant, enable server staff in a retail establishment to initiate orders for those guests without smart devices and to communicate those orders to the backend server 200; to receive communications from the backend server that synchronize an order taken by one POS terminal 300 with other POS terminals 300 in the establishment; to receive guest pages from the backend server 200, to receive fulfillment pages from the backend server 200, to receive payment authorization pages and payment instructions from the backend server 200; to receive communications from the backend server 200 indicating completion of the transaction, and to receive feedback data from the backend server 200 corresponding to completed order tickets.

The configuration process 308 may be employed upon power up of the terminal 300 to configure the terminal 300 for a specific function such as a host POS terminal, a self-serve kiosk, an order processing/fulfillment terminal, an expediter terminal, or a server POS terminal, and to communicate such configuration details to the backend server 200.

SYNC 309 may execute to receive order progress and status from the backend server 200 for order ticket to which the terminal 300 is assigned, along with order progress and status for all orders within the restaurant.

GUEST PARTY 310 may execute to receive guest pages for service as communicated by the backend server 200. MULTI GUEST 311 executes to coordinate pages via the backend server 200 with other terminals 300 assigned to a party.

HANDOFF 312 executes to receive communications from the backend server 200 notifying server staff that arrivals of guests have been detected/determined, along with instructions for escorting them to their table for service.

FULFILLMENT 313 executes to manage the preparation progress and status of items ordered that are associated with the terminal 300 and that are received from the backend server 200 so that the server may inform guests if required. COURSING 314 executes to aggregate preparation progress and status of items ordered within a course. Preferably, the preparation progress and status received from the backend server 200 contains details that are not communicated to the guest devices, but that are useful for servers.

PAYMENT 315 executes to receive payment pages from the backend server 200 to interact with guests to resolve payment splitting conflicts, to receive payment status for each of the guests, and to receive pages from the backend server 200 to prompt guests that have not paid to make payment. For guests that have left without paying, PAYMENT 315 may collect payment by processing a preauthorized payment instrument to collect funds due along with a corresponding tip percentage.

FEEDBACK 317 executes to receive guest feedback from the backend server 200 along with tip details and status of tips for a period of time (e.g., evening, week, month, etc.)

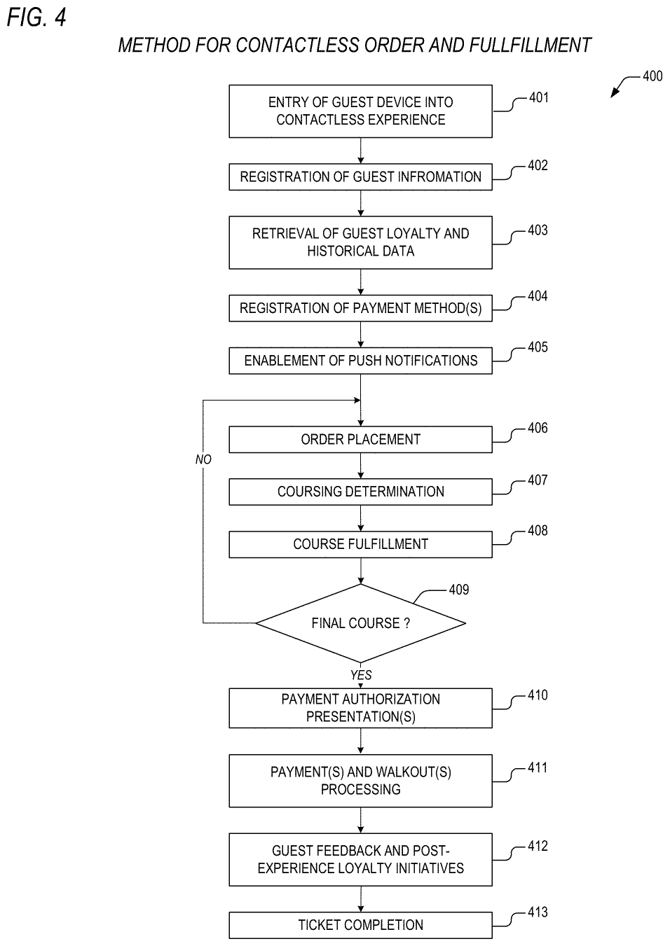

Now turning to FIG. 4, a flow diagram 400 is presented showing a method according to the present invention for contactless order and fulfillment. Flow begins at block 401 when a guest enters their smart device into contactless experience via making a reservation for a party, adding a party to a waitlist, or by walking into the restaurant and requesting a table. At this point, the party and guests are associated with an order ticket that is opened by the backend server 200. Flow the proceeds to block 402.

At block 402, registration of guest information occurs. Preferably, the system 100 may retrieve guest name, guest smart device number, and a payment instrument for the guest through the proprietary application or app clips executing on the smart device, through 3^{rd} party reservation/waitlist applications, through social media, or by directly requesting the information from the guest. Registration requests for information may be sent to the guest device via the proprietary application (app clip) or via a hyperlink embedded in a text message, email, or social media message. Instructions are provided to the guest to invite other guests in the party to provide their respective information. At a minimum, a first name of a guest is required along with the guest's smart device number and payment instrument. Preferably, each guest will register full name, smart device number, and one or more payment instruments. Flow then proceeds to block 403.

At block 403, the backend server 200 may access the loyalty database 224 to retrieve loyalty data for each guest in a party as described above along with those guest's historical purchase and preference data. The loyalty data and historical purchase/preference data may be employed by the system 100 to personalize menus for the guests and to tailor those menus for likely upsells based on the previous experiences at the restaurant or other restaurants in the subscription service. Flow then proceeds to block 404.

At block 404, payment records are updated or created in the payment database 223 as described above based on the payment instruments received from the guests at block 402. Flow then proceeds to block 405.

At block 405, guests having the proprietary application or app clip may enable push notifications from the backend server. Flow then proceeds to block 406.

At block 406, each registered guest in the party may receive personalized menus from the system 100 via the proprietary application app clip; a web interface accessed via a hyperlink provided in a push notification, text message, social message, or email; or through any of the aforementioned detection/determination mechanisms (QR code, NFC code, etc.) upon arrival at the restaurant. Prior to arrival and after arrival, guests are seated and each guest may order one or more items from their respective menu and may select from one or more coursing instructions such as, but not limited to, “Upon Arrival,” “ASAP,” “Salad Course,” “Appetizer Course,” “Main Course,” or “Dessert Course,” where the coursing instructions are configured according to type of restaurant. Flow then proceeds to block 407.

At block 407, the backend server 200 may determine what items for all guests at a table are to be included in a particular course, and the items along with their determined courses are transmitted by the backend server 200 to order fulfillment terminals in the restaurant for preparation of the items within the courses. Flow then proceeds to block 408.

At block 408, all items within a course are prepared. The order fulfillment terminals notify the backend server 200 of their completion and the backend server 200 notifies the server POS terminals for the table to deliver the prepared items. Flow then proceeds to decision block 409.

At decision block 409, based upon notifications provided by the guests, the backend server 200 evaluates whether a final course has been delivered or not. In one embodiment, the backend server determines a final course if a prescribed time period has transpired since items were ordered, say, 1 hour. In another embodiment, the backend server 200 page servers to the table to inquire. In a further embodiment, each guest may indicate by selecting an icon (i.e., “I'm Finished”) on their smart device, data for which is messaged to the backend server 200. If a final course has not been delivered, then flow proceeds to block 406. If a final course has been delivered, then flow proceed to block 410.

At block 410, the backend server 200 transmits payment authorization display presentations to each of the guest devices that enable each guest to elect payment terms (e.g., pay for whole table, split with other guests, pay a specific amount, pay only for items ordered on their smart device), apply a tip, select a payment instrument, and authorize processing of a transactions using the selected payment instrument. Flow then proceeds to block 411.

At block 411, the backend server 200 may process payments using the selected payment instruments as described above to close out the open ticket. The backed server 200 may optionally determine if one or more guests have walked without paying and may message the guest to provide payment or automatically collect payment using a registered payment instrument. Flow then proceeds to block 412.

At block 412, the backend server 200 may transmit loyalty incentives to each guest device (via proprietary application, app clip, email link, etc.) and may further solicit feedback on the contactless experience. Flow then proceeds to block 413.

At block 413, when full payment of the order ticked has been processed and feedback is received or declined, the backend server marks the ticket as complete, receipts the smart devices that paid, and notifies the server POS terminals with tip details and feedback.

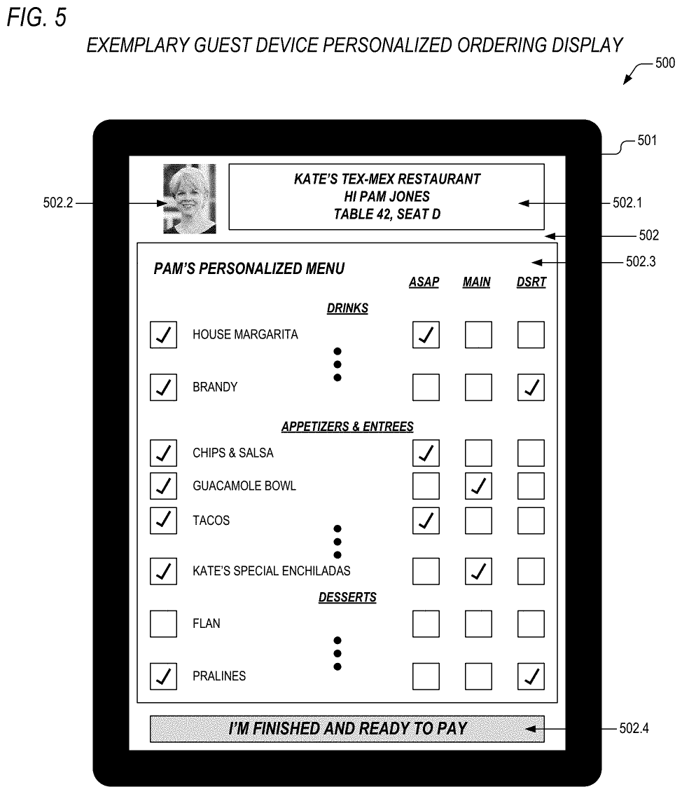

Referring now to FIG. 5, a diagram illustrating an exemplary guest device personalized ordering display on a guest's smart device 500. The smart device 500 may comprise a housing 501 and touchscreen display 502 such as exhibited on an iPhone or Android phone. The display 502 may comprise a greeting area 502.1 that identifies the restaurant, a registered guest (“Pam Jones”), and that shows where the guest is seated (“Table 42, Seat D”). The display 502 may also comprise a photo 502.2 of the registered guest, if available. This photo 502.2 may additionally be provided to assigned servers via their mobile POS terminals. The display 502 may additionally comprise a personalized menu area 502.3 that include menu items selected from an overall restaurant menu based on historical orders/preferences retrieved from the loyalty database 224 and which are likely upsells. The menu area 502.3 may provide interactive controls for the guest to select items to order and to designate courses for those items. In the menu area 502.3 shown, selectable courses are “ASAP,” “MAIN,” and “DSRT,” since this restaurant is not configured to fulfill other forms of courses. The present invention contemplates selectable course designations for any restaurant to comport with that restaurant's service objectives. As one skilled in the art will appreciate, coursing runs the spectrum from fast food courses to multiple-course fine dining establishments. Note that guest Pam Jones has ordered two drinks from the drink portion of the menu and has designated one for ASAP and the other for dessert.

The display 502 may further comprises a meal completion icon area 502.4 that the guest can select to inform the backend server 200 that she is finished and ready to pay.

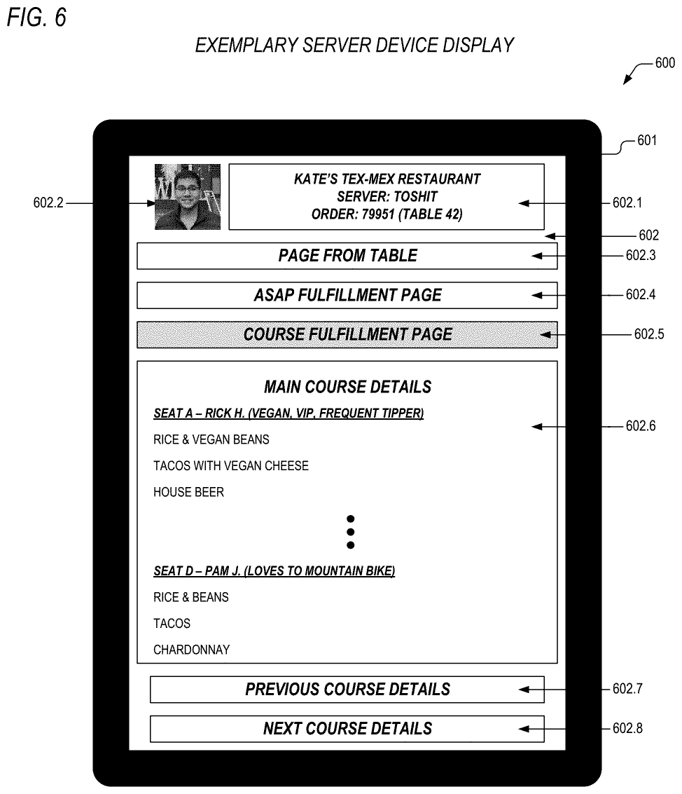

Turning now to FIG. 6, is a diagram is presented detailing an exemplary display on a server POS terminal 600 according to the present invention. The server POS terminal 600 is programmed as a special purpose computer to communicate with the backend server 200 and may comprise a housing 601 and touchscreen display 602. The display may comprise a header area 602.1 that identifies the restaurant, the server (“Toshit”), assigned order number (“79951”) and table to which the order is assigned (“Table 42”). The display 602 may further include a photo 602.2 of the server to enable staff to easily distinguish ownership of the POS terminal 600. The display 602 may additionally comprise a table page notification area 602.3 that may flash or change color to alert the server to attend to guests at the table. A page of any sort may additionally cause the terminal 600 to vibrate or generate an audible alert. The display 602 may also comprise an immediate fulfillment page area 602.4 that alerts the server to deliver one or more items to the table that the guests have designated as “ASAP.” The display 602 may moreover comprise a course fulfillment page area 602.5 that alerts the server to deliver items in a course that have been prepared. The display 602 may additionally comprise a course details area 602.6 corresponding to a current course for which the sever has been alerted, in this instance, a main course. The course details area 602.6 shown in the diagram includes items ordered by each of the guests in that course along with information retrieved from the loyalty database 223 that may be employed by the server to upsell items and focus his efforts on maximizing tips. The display 602 may also comprise a previous course selection link 602.7 and a next course selection link 602.8 that the server may actuate to bring up corresponding course details in the course details area 602.6 for a previous course and a next course.

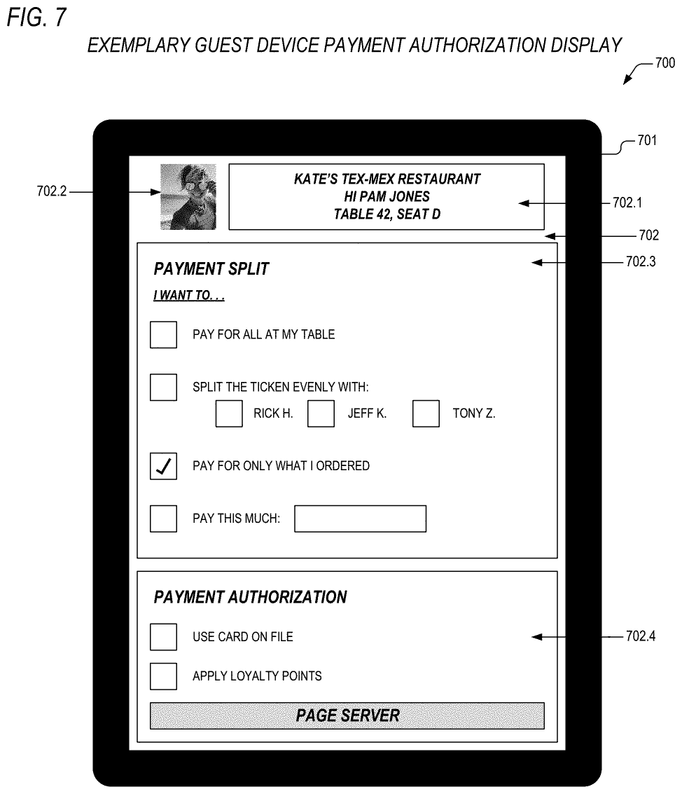

Referring to FIG. 7, a diagram is presented showing an exemplary guest device payment authorization display on a guest device 700 according to the present invention. The guest device 700 is as described above and may comprise a housing 701 along with a touchscreen display 702. The display 702 may have a greeting area 702.1 and a photo 702.2 as are described above with reference to FIG. 5. The display 702 may further comprise a payment instructions area 702.3 whereby the guest may select how she wants to pay for service. In the display area 702.3 shown, the guest may select to pay the entire check, split the check with one or more other guests at the table, pay for only what she ordered, or pay a prescribed amount. Other embodiments are contemplated for payment instructions. The display 702 further comprises a payment authorization area 702.4 that enables the guest to apply loyalty/gift card points for payment, to use a registered payment interest, or both. The authorization area 702.4 may also include a control to page a server to the table so that the guest can provide additional payment instructions, including providing an alternative payment instrument.

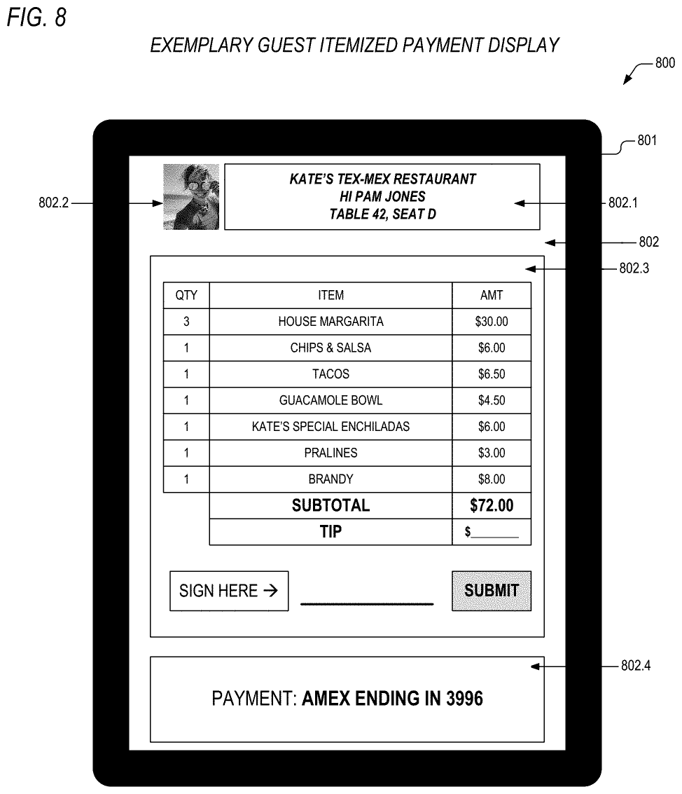

Finally referring to FIG. 8, a diagram is presented illustrating an exemplary guest itemized payment display on a guest device 800 according to the present invention. The guest device 800 is as described above and may comprise a housing 801 along with a touchscreen display 802. The display 802 may have a greeting area 802.1 and a photo 802.2 as are described above with reference to FIG. 5. The display 802 may also comprise a payment details area 802.3 showing all of the items for which the guest has elected to pay along with a subtotal, optional tip fill-in area, and payment authorization signature area. The payment details area 802.3 may further provide a control “Submit” that the guest may select to initiate payment processing by the backend server 200. The display may additionally comprise a selected payment instrument area 802.4 showing a truncated or abridged number associated with the selected payment instrument.

Portions of the present invention and corresponding detailed description are presented in terms of software or algorithms, and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, a microprocessor, a central processing unit, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be electronic (e.g., read only memory, flash read only memory, electrically programmable read only memory), random access memory magnetic (e.g., a floppy disk or a hard drive) or optical (e.g., a compact disk read only memory, or “CD ROM”), and may be read only or random access. Similarly, the transmission medium may be metal traces, twisted wire pairs, coaxial cable, optical fiber, or some other suitable transmission medium known to the art. The invention is not limited by these aspects of any given implementation.

The particular embodiments disclosed above are illustrative only, and those skilled in the art will appreciate that they can readily use the disclosed conception and specific embodiments as a basis for designing or modifying other structures for carrying out the same purposes of the present invention, and that various changes, substitutions and alterations can be made herein without departing from the scope of the invention as set forth by the appended claims. For example, components/elements of the systems and/or apparatuses may be integrated or separated. In addition, the operation of the systems and apparatuses disclosed herein may be performed by more, fewer, or other components and the methods described may include more, fewer, or other steps. Additionally, unless otherwise specified steps may be performed in any suitable order.

Although specific advantages have been enumerated above, various embodiments may include some, none, or all of the enumerated advantages.

What is claimed is:

1. A method for a contactless order and fulfillment experience in a retail establishment, the method comprising:
via an off-site server:
opening an electronic order ticket upon receipt of a reservation or waitlist communication initiated by a guest device associated with a guest;
receiving an order from the guest device, the order including one or more initial items from a menu;
receiving initial coursing instructions for the one or more initial items from the guest device;
adding the one or more initial items to the electronic order ticket;
upon arrival of the guest at the retail establishment, receiving additions to the order from the guest device including one or more additional items from the menu;
receiving additional coursing instructions for the one or more additional items from the guest device;
adding the one or more additional items to the electronic order ticket; and
transmitting one or more notifications to a point-of-sale (POS) terminal to deliver prepared items to the guest in accordance with the initial and additional coursing instructions.

2. The method as recited in claim 1, further comprising:
receiving, at the off-site server, a credit card number from the guest device.

3. The method as recited in claim 1, further comprising:
transmitting, via the off-site server, status data for the electronic order ticket to one or more POS terminals in the retail establishment.

4. The method as recited in claim 3, further comprising:
via the off-site server, transmitting an indication of an order status to the guest device.

5. The method as recited in claim 1, further comprising:
via the off-site server:
transmitting the initial and additional items to one or more fulfillment terminals in the retail establishment in accordance with the initial and the additional coursing instructions; and
receiving notifications from the one or more fulfillment terminals indicating finished preparation of the initial and the additional items.

6. The method as recited in claim 1, further comprising:
via the off-site server:
receiving a service page from the guest device; and
transmitting an alert to the POS terminal to attend to the guest.

7. The method as recited in claim 1, wherein communications between the off-site server and the guest device includes sending and receiving data through a thin-client web interface.

8. A method for a contactless order and fulfillment experience in a restaurant, the method comprising:
via an off-site server:
opening an electronic order ticket upon receipt of a reservation or waitlist communication initiated by a guest device associated with a guest;
receiving an order from the guest device, the order including one or more initial items from a menu;
receiving initial coursing instructions for the one or more initial items from the guest device;
adding the one or more initial items to the electronic order ticket;
upon arrival of the guest at the restaurant, receiving additions to the order from the guest device including one or more additional items from the menu;
receiving additional coursing instructions for the one or more additional items from the guest device;
adding the one or more additional items to the electronic order ticket; and
transmitting one or more notifications to a point-of-sale (POS) terminal to deliver prepared items to the guest in accordance with the initial and additional coursing instructions.

9. The method as recited in claim 8, further comprising:
receiving, at the off-site server, a credit card number from the guest device.

10. The method as recited in claim 8, further comprising:
transmitting, via the off-site server, status data for the electronic order ticket to one or more POS terminals in the restaurant.

11. The method as recited in claim 10, further comprising:
via the off-site server, transmitting an indication of an order status to the guest device.

12. The method as recited in claim 8, further comprising:
via the off-site server:
transmitting the initial and additional items to one or more fulfillment terminals in the restaurant in accordance with the initial and the additional coursing instructions; and
receiving notifications from the one or more fulfillment terminals indicating finished preparation of the initial and the additional items.

13. The method as recited in claim 8, further comprising:
via the off-site server:
receiving a service page from the guest device; and
transmitting an alert to the POS terminal to attend to the guest.

14. The method as recited in claim 8, wherein communications between the off-site server and the guest device includes sending and receiving data through a thin-client web interface.

15. A system for a contactless order and fulfillment experience in a retail establishment, the system comprising:
an off-site server, configured to:
open an electronic order ticket upon receipt of a reservation or waitlist communication initiated by a guest device associated with a guest;
receive an order from the guest device, the order including one or more initial items from a menu;
receive initial coursing instructions for the one or more initial items from the guest device;
add the one or more initial items to the electronic order ticket;
upon arrival of the guest at the retail establishment, receive additions to the order from the guest device comprising one or more additional items from said menu;
receive additional coursing instructions for the one or more additional items from the guest device;
add said additional items to said electronic order ticket; and
transmit one or more notifications to a point-of-sale (POS) terminal to deliver prepared items to the guest in accordance with the initial and additional coursing instructions.

16. The system as recited in claim 15, wherein said off-site server is further configured to:
receive a credit card number from the guest device.

17. The system as recited in claim 15, wherein said off-site server is further configured to:
transmit status data for said electronic ticket to one or more POS terminals in the establishment.

18. The system as recited in claim 15, wherein said off-site server is further configured to:
transmit an indication of order status to the gust device.

19. The system as recited in claim 15, wherein said off-site server is further configured to:
transmit said initial and said additional items to one or more fulfillment terminals in the retail establishment in accordance with said initial and said additional coursing instructions; and
receive notifications from said one or more fulfillment terminals indicating finished preparation of said initial and said additional items.

20. The system as recited in claim 15, wherein said off-site server is further configured to:
receive a service page from said guest device; and
transmit an alert to said mobile POS terminal to attend to said guest.
